(19) United States
(12) Patent Application Publication
(10) Pub. No.: US 2024/0303263 A1
(43) Pub. Date: Sep. 12, 2024

(54) SYSTEMS AND METHODS FOR PREDICTIVE OUTPUTS AND KEY DRIVERS

(71) Applicant: MicroStrategy Incorporated, Tysons Corner, VA (US)

(72) Inventor: Ananya OJHA, Dunn Loring, VA (US)

(73) Assignee: MicroStrategy Incorporated, Tysons Corner, VA (US)

(21) Appl. No.: 18/595,960

(22) Filed: Mar. 5, 2024

Related U.S. Application Data
(60) Provisional application No. 63/488,733, filed on Mar. 6, 2023.

(51) Int. Cl. G06F 16/335; G06F 16/383

(52) U.S. Cl. CPC G06F 16/335; G06F 16/383

(57) ABSTRACT

A method for providing predictive outputs and key drivers may include receiving a prompt from a user, providing the prompt to an artificial intelligence process, receiving, from the artificial intelligence process, an analysis of the prompt, the analysis including one or more of: an identified type of predictive data requested, one or more identified metrics related to the prompt, one or more identified data attributes related to the prompt, a determined granularity of data for a response, one or more filters applied to data related to the prompt, and a determined timeframe of analysis for a response; retrieving data related to the prompt, applying the one or more filters to the data, generating the identified type of predictive data according to the one or more metrics, the one or more data attributes, the granularity of data, and the timeframe of analysis, and presenting the generated predictive data to the user.

### CROSS-REFERENCE TO RELATED APPLICATION

This application claims benefit to U.S. Provisional Patent Application No. 63/488,733, filed Mar. 6, 2023, the entire contents of which are incorporated herein by reference.

### TECHNICAL FIELD

The present disclosure relates to systems and methods for information monitoring for determining predictive outputs and key drivers.

### INTRODUCTION

Electronic networks and databases often include more information than is possible for a user to efficiently search and/or analyze. A user may utilize a search engine to look up information, but this may lead to frustration, as the user may not know how to acquire the most relevant information for determining future actions based on relevant data.

The introduction provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment in which systems methods and other aspects of the present disclosure may be implemented.

FIG. 2 depicts a system flow diagram of a system for providing predictive outputs, according to one or more embodiments

FIG. 3A depicts an example time series forecast, according to one or more embodiments.

FIG. 3B depicts an additional example time series forecast, according to one or more embodiments.

FIG. 4 depicts charts providing trends to determine predictive outputs, according to one or more embodiments.

FIG. 5 depicts an example trend analysis, according to one or more embodiments.

FIG. 6 depicts a flowchart for providing predictive outputs, according to one or more embodiments.

FIG. 7A depicts example subcategory key drivers, according to one or more embodiments.

FIG. 7B depicts additional example subcategory key drivers, according to one or more embodiments.

FIG. 8 depicts a flowchart for determining key drivers, according to one or more embodiments.

FIG. 9 is a data flow for training a machine learning model, according to embodiments of the present disclosure.

FIG. 10 depicts an exemplary computer device or system, in which embodiments of the present disclosure, or portions thereof, may be implemented.

Like reference numbers and designations in the various drawings indicate like elements.

### SUMMARY OF THE DISCLOSURE

According to certain aspects of the present disclosure, systems and methods are disclosed for providing predictive outputs and key drivers.

In one embodiment, a computer-implemented method is disclosed for providing predictive outputs and key drivers, the method comprising: receiving a prompt from a user, providing the prompt to an artificial intelligence process, receiving, from the artificial intelligence process, an analysis of the prompt, the analysis including one or more of: an identified type of predictive data requested, one or more identified metrics related to the prompt, one or more identified data attributes related to the prompt, a determined granularity of data for a response, one or more filters applied to data related to the prompt, and a determined timeframe of analysis for a response; retrieving data related to the prompt, applying the one or more filters to the data, generating the identified type of predictive data according to the one or more metrics, the one or more data attributes, the granularity of data, and the timeframe of analysis, and presenting the generated predictive data to the user.

In accordance with another embodiment, a system is disclosed for providing predictive outputs and key drivers, the system comprising: a data storage device storing instructions for providing predictive outputs and key drivers in an electronic storage medium; and a processor configured to execute the instructions to perform a method including: receiving a prompt from a user, providing the prompt to an artificial intelligence process, receiving, from the artificial intelligence process, an analysis of the prompt, the analysis including one or more of: an identified type of predictive data requested, one or more identified metrics related to the prompt, one or more identified data attributes related to the prompt, a determined granularity of data for a response, one or more filters applied to data related to the prompt, and a determined timeframe of analysis for a response; retrieving data related to the prompt, applying the one or more filters to the data, generating the identified type of predictive data according to the one or more metrics, the one or more data attributes, the granularity of data, and the timeframe of analysis, and presenting the generated predictive data to the user.

In accordance with another embodiment, a non-transitory machine-readable medium storing instructions that, when executed by a computing system, causes the computing system to perform a method for providing predictive outputs and key drivers, the method including: receiving a prompt from a user, providing the prompt to an artificial intelligence process, receiving, from the artificial intelligence process, an analysis of the prompt, the analysis including one or more of: an identified type of predictive data requested, one or more identified metrics related to the prompt, one or more identified data attributes related to the prompt, a determined granularity of data for a response, one or more filters applied to data related to the prompt, and a determined timeframe of analysis for a response; retrieving data related to the prompt, applying the one or more filters to the data, generating the identified type of predictive data according to the one or more metrics, the one or more data attributes, the granularity of data, and the timeframe of analysis, and presenting the generated predictive data to the user.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### DETAILED DESCRIPTION OF EMBODIMENTS

The subject matter of the present description will now be described more fully hereinafter with reference to the accompanying drawings, which form a part thereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter can be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially,” “approximately,” and “generally,” are used to indicate a possible variation of +10% of a stated or understood value.

In the following description, embodiments will be described with reference to the accompany drawings. Various embodiments of the present disclosure relate generally to methods and systems for information monitoring for contextually-relevant data.

As described above, users searching or monitoring contextually-relevant information may be overwhelmed with the amount of information available and have difficulties monitoring the information. Contextually-relevant information may be made up of a plurality of data points. In many conventional systems, users may have to keep track of individual data points manually by looking up and/or searching for individual sources of the data points. Users may also have to create reminders or alerts to monitor the individual data points. For example, the users may set up a to-do list or a reminder email to search and monitor each individual data point at a frequency that is appropriate for the users. Additionally, users may be provided current or past data but may not be able to forecast future trends based on the current or past data. For example, users may not be able to forecast future trends in view of supplementary or complimentary information, based on seasonality, variability, or the like.

A further challenge arises since the contextually-relevant information may be assembled from a plurality of data sources, including third party data sources, which may make the process slow and degrade the user experience. Similarly, supplementary or complementary external information, seasonality, and/or variability of contextually-relevant information may fluctuate and, accordingly, may not be applicable based on current and/or past data.

The techniques discussed herein address these and other challenges by tracking data that is selected or presented to a user (e.g., via one or more applications). The tracked data may be analyzed in a contextually relevant format to predict trends associated with the data. The tracked data may be tracked across one or more databases, one or more sources, or the like. The tracked data may be analyzed for seasonality, variability, and the like to predict trends associated with the data. Alternatively, or in addition, external supplementary or complementary information may be identified based on the tracked data to predict trends based on the supplementary or complementary information. Key drivers that drive changes to tracked data may be identified using a semantic architecture.

According to an implementation, a user may call up monitored data within a central user interface and/or may switch applications or look through multiple data sources to receive data. Such data may be contextually-relevant data such that the data may be analyzed in view of historical trends, relationships, or the like. Such contextually-relevant data may be provided to a user with one or more visualizations, trends, predictions, summaries, and/or the like or a combination thereof.

The user's access (e.g., interaction, request, receipt, view, etc.) to such data may be tracked to identify user relevant data. User relevant data may be a subset of data available to the user, the subset including data that is prioritized by the user. The prioritization may be based on a level of access, a level of interaction, a number or frequency of requests, a number or frequency of receipt, and/or the like associated with the subset of data. For example, priority scores for data within the subset of data may meet a priority threshold whereas priority scores for data outside the subset of data may not meet the priority threshold. The priority threshold may be a numerical value, a tier, a level, or the like. A priority score may be a numerical value, a tier, a level, or the like that categorizes data based on the user's prioritization of the data, as determined based on the tracking. Alternatively, or in addition, user relevant data may be data that is identified by a user as user relevant data (e.g., data that the user indicates as priority data, based on, for example, an input via an interface).

As an example, a user's access (e.g., interaction, request, receipt, view, etc.) to such data may be tracked based on monitoring the number or frequency of times a given type of data is accessed. The tracking may be based on access logs, pixel tracking, data pulls, or the like. For example, a data log may iterate a counter for each instance of a data pull of a type of data. The data log may be accessed to extract a counter count for the type of data such that the count indicates the number of times the type of data is accessed. A priority score for a given type of data or given data may be determined based on such access.

According to an implementation, a set of data points associated with data such as user relevant data may be stored using a semantic architecture that includes multiple dimensions associated with the set of data points. The semantic architecture may allow access to trusted enterprise data and to quickly build reports and visualizations, blending data from multiple systems. The systems and components disclosed herein may use the semantic architecture to produce actionable intelligence from structured, unstructured, and semi-structured data warehouses, enterprise directories, and other enterprise data assets. The semantic architecture may allow logical business abstraction of enterprise data assets combined with an object-oriented architecture to facilitate object reusability, trusted governance, and user collaboration. The semantic architecture may further facilitate provision of governed, self-service analytics. The semantic architecture may be implemented by using a semantic layer that functions as an index of and/or on top of an organization's enterprise data assets.

A semantic layer may index a set of data points such that correlations, relationships, and/or the like based on categories and/or subcategories associated with the set of data points are stored at the semantic layer. The semantic layer may be implemented at an entity (e.g., organization) or division (e.g., a subset of an organization) level. Accordingly, a semantic layer may store correlations, relationships, and/or the like for categories and/or subcategories across an entity and/or one or more divisions.

In some implementations, a computer system has multiple machine learning models that are available to generate output for users or otherwise adjust a user's experience. The system can represent a variety of machine learning models as objects in a semantic graph, to facilitate the system selectively and conditionally applying different models for different situations. Models represented in the semantic graph can be connected to other types of objects (e.g., users, documents, endpoint devices, locations, customers, etc.) through edges with and corresponding edge weights. The edges and their weights can be used by the system to select, for example, which model(s) should be used for a given user, document, task, or situation. The weights and edges are updated so that, for a given function or UI element, the model used will vary based on the customer, user group, or device invoking the function, which customizes the result different users see.

The use of the semantic graph can provide many features and advantages in analytics systems. For example, the system can provide autonomous self-optimization, as the system learns which models are best to use for different situations and encodes the information in connections and weights of the semantic graph. The system can use machine learning models to provide data architects assistance in writing and analyzing structured query language (SQL). The models can also be used to generate schema models based on data warehouse structure. In many cases, the system can use machine learning models to generate dashboards, reports, dossiers, and other documents based on datasets or topics that leverage digital asset collections of the platform or of a specific enterprise.

The computer system can include an engine, such as a semantic graph service, that uses the semantic graph to answer questions. When a user has a question or idea, many current interfaces constrict a user to interacting in specific ways set by the interface designer. For example many software interfaces have predetermined sets of buttons and other controls, and respond to predetermined sets of keywords. In effect, users are forced to learn the language of the software user interface. With the semantic graph combined with machine learning models, users can perform complex data analytics tasks without the traditional constraints. For example, a user may have a natural language question to pose, which uses business terms which may be specific to the user's company. The system can use the semantic graph and a machine learning model to generate the SQL that operates to retrieve the answer to the natural language question (e.g., retrieve the appropriate data from tables, memory, data cubes). A data store or database server processes the generated SQL query and returns the requested information to the user.

As another example, the machine learning models guided using the semantic graph may better understand the terminology and vocabulary of a particular enterprise, to better generate documents and reports. Instead of or in addition to using traditional data cataloging tools, metadata and terminology across broad data sets can be captured in a semantic graph and used to improve the operation of machine learning models. In many cases, machine learning models such as large language models can be used to process information about data warehouses or data catalogs to generate metadata or semantic graph data.

Another way that a machine learning model can be used is to use a machine learning model to generate metadata for an enterprise from a data catalog or data source. For example, a machine learning model can be trained to receive a data catalog as input and to generate metadata or semantic graph data as an output. Many different organizations would benefit from deriving a data scheme or metadata repository from a data catalog or data repository. As a result, a machine learning model can be trained with examples of (1) data sets or data catalogs and (2) corresponding data schema or metadata. The model can learn to extract or infer the data schema or metadata for a data set or organization in response to receiving input of data catalog information or portions of the data set itself. Thus, the model can use a data catalog as the source of the terminology for a schema, metadata repository, and/or semantic graph. In some implementations, the generated schema or metadata repository is an intermediate representation that is used by a database system or by machine learning models for interacting with the data set, and it may not be presented or viewed by users. In some implementations, the object definitions, connections, and terms can be incorporated into a semantic graph and used to enhance many other data analytics operations.

According to implementations disclosed herein, forecasts (e.g., forecasted changes, trends, etc.) associated with user relevant data and/or user relevant data types (user relevant data) may be generated. The forecasts may be based on trends and/or seasonality associated with user relevant data. The forecasts may further be based on a semantic architecture (e.g., one or more semantic graphs) associated with a given entity. For example, user relevant data trends and/or seasonality may be analyzed in view of the semantic architecture and associated data. A user relevant data forecast may be generated based on the trends, seasonality, and/or semantic architecture.

As further discussed herein, a key driver analysis may be conducted to determine key data drivers that effect changes to user relevant data. The key driver analysis may identify such key drivers and the semantic architecture may be used to apply such key drivers to generate user relevant data analysis (e.g., for forecasting).

According to implementations disclosed herein, a user query may be provided by a user (e.g., via a natural language query input). The query may be input into a generative machine learning model trained, at least in part, based on training data associated with a given organization dataset. The given organization dataset may be associated with the organization associated with the user or the user query. The generative machine learning model may be trained to receive the user query as an input, and to provide an output associated with the user query based on training the generative machine learning model using the organization specific dataset. Accordingly, the generative machine learning model may be trained to analyze the user input query in view of a given organizations data including the given organizations vocabulary, data, semantic graph, trends, metrics, and/or the like. The generative machine learning model may generate an output that translates the user query (e.g., a natural language user query) into a computer understandable query (e.g., in a format that can be provided to a database to retrieve a response to a natural language user query).

Accordingly, the techniques in the present application may be used to automatically provide contextually-relevant information, forecasts, and/or key drivers to a user (e.g., via an interface, overlapping/adjacent an interface, etc.) when and/or where the user can access such information without switching between applications and/or interfaces. Such information may be automatically generated such that a user may receive such information without constant or periodic requests for the same. Such information may be provided at user determined intervals, or may be provided when attributes of the contextually-relevant information meet a trigger threshold (e.g., a change in values, a rate of change, a trend, etc.).

This automatic provision of contextually-relevant information, forecasts, and/or key drivers may provide information to just the right user, at the right time, at the user interface where the information is needed. Delays may be reduced because a client device may receive such information before the user indicates that the information should be displayed. Also, the user may call up the information with a single action on the existing interface, such as a mouse-over, hover, click, gaze, gesture, or tap on a term in the user interface. While the term “cursor” may be used herein, this term may also indicate points of user focus on the screen even though no visible cursor is present. For example, a user placing a finger on a touchscreen may indicate a point of user focus that may be called a cursor, even though a visible cursor might not be present.

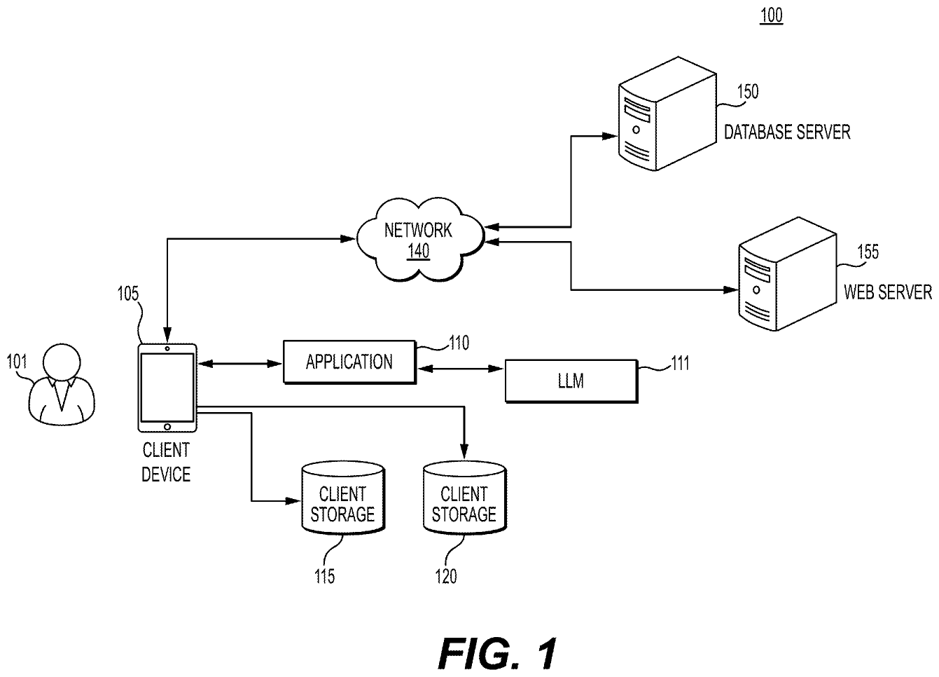

FIG. 1 depicts an exemplary environment 100 in which systems, methods, and other aspects of the present disclosure may be implemented. The environment 100 may include one or more client devices 105, one or more database servers 150, and/or one or more web servers 155. The client device 105, database server 150, and web server 155 may communicate with each other via one or more networks 140. The network 140 may be any suitable network or combination of networks and may support any appropriate protocol suitable for data communication between various components in the system environment 100. The network 140 may include a public network (e.g., the Internet), a private network (e.g., a network within an organization), or a combination of public and/or private networks. The database server 150 may be implemented using multiple computers that cooperate to perform the functions discussed below, and which may be located remotely from each other.

The client device 105 may include an application 110 that enables the client device 105 to dynamically generate and display contextually-relevant information inline with, or adjacent to, the application 110 on an electronic display of the client device 105. As discussed below, the application 110 may allow the client device 105 to obtain and provide information from the database server 150 and the web server 155, even though the application 110, which may access a web page or app, may be controlled by third parties.

The client device 105 may be associated with a user 101, who may be a member of an organization, e.g., an employee of a company. The database server 150 may store database records stored by or for the user or the organization. The records might not be publicly available and may be subject to data access restrictions, such as requirements that users be issued credentials, for example from the organization, that grant authorization to access the records. Different users may be granted different levels of authorization, and the database server 150 may enforce access restrictions so that each user is only allowed to access the subsets of information the user is authorized to access. Techniques used herein may also accumulate data from publicly available databases for displaying contextually-relevant information.

In the environment 100, instead of incorporating additional content into the source of a document or application, information may be instead added, just in time, through the application 110, for example, a browser extension for a web browser, a subroutine of application 110, etc. This provides the flexibility for the system to selectively provide dynamically changing content from the database server 150 for any interface shown on the application 110, e.g., any web application or web page displayed by a web browser, any user interface displayed on the electronic display of the client device 105, etc.

In the example of FIG. 1, the client device 105 may communicate with the web server 155 to obtain and display a page of a web site or other user interface of the application 110. Web server 155 may make available an Application Programming Interface (API) through which information may be provided. Alternatively, application 110 may comprise a native desktop application, and may require no communication or minimal communication with web server 155. The client device 105 may generate an electronic display for the application 110, or may generate displays in the electronic display for more than one application. Concurrently, the application 110 may run on the client device 105 and may receive the text content of the rendered page. The electronic display may comprise a desktop displaying one or more applications, including application 110.

The application 110 may require the user 101 to authenticate and thus prove authorization to receive content from the database server 150. The authentication of the user 101 may also indicate to the application 110 and/or database server 150 the role of the user in the organization (e.g., software engineer, marketing technician, financial analyst, and so on) and the specific level of access authorization that has been, or will be, granted to the user 101 by the organization.

Application 110 may employ an artificial intelligence process, such as a large language model (LLM), such as LLM 111, to process a user query. For example, application 110 may provide one or more of the user query, metadata describing available data, such as for example, names and/or descriptions of data metrics and/or attributes, and sample data to LLM 111. LLM 111 may then process the user query and provide an output based on the query such as, for example, an output that translates the nature of the query or the type of analysis requested, one or more metrics that are the subject of the user query, one or more data attributes that may be employed to respond to the user query, a granularity needed to respond to the user query (such as, for example data per hour, day, month, quarter, year, etc.), other filters to be applied to the data, a timeframe of analysis for a response to the user query (such as, for example, a particular region or a particular category of goods or services), a timeframe of analysis for a response to the user query (such as, for example, a trend over a particular period of time or a forecast for a particular period of time into the future).

The data used for the analysis may be trusted or “governed” data, such as may be provided by a business intelligence system. For example, dossiers, documents, reports, datasets, and cubes can be certified by users with certain permissions. Certified items may typically be reviewed by trusted systems or components of an organization and may be considered official sources of content, based on reliable data.

If attributes of the available data do not match what is needed to respond to the user query, LLM 111 may determine whether data may be transformed to match the user query. For example if a user query requests a trend of revenue by month, but only daily revenue data is available, LLM 111 may determine that the daily revenue data may be transformed to monthly revenue. Such a granularity transformation may be applied in a time dimension, such as data per millisecond, second, minute, hour, day, month, quarter, year, etc. If such data may be transformed, the LLM 111 may output a computer understandable query that includes a process required to output the transformed data request. Some analysis types may not be subject to such transformations. For example, in some embodiments, a time series forecast analysis and a trend analysis may include data transformation, such as by LLM 111, but a key driver analysis may not. LLM 111 may identify such analysis types that are not subject to such transformations and may generate an indicator that indicates that such analysis types are not subject to such transformations. The indicator may be output to a user device and/or to a system component.

LLM 111 may be incorporated as a component of the system, such as, for example, as component of application 110, or may be independent of the system and/or provided by a third party. As such, LLM 111 may be a general-purpose LLM for processing natural language and related data, or may be specially trained to process queries related to the type of analyses provided by the system.

LLM 11 may be stateless in the sense that LLM 111 may not record user queries, user refinement of queries, or responses by LLM 111. However, in other embodiments, LLM 111, or another component of the system, such as application 110, may record and evaluate such data in order to improve the response of the system to user queries, including the operation of LLM 111.

With the user logged in, the application 110 may access a set of data points, e.g., contextually-relevant data, that are relevant to the user 101 and/or the organization. The set of data points may be stored at the client device 105 or may be stored in the database server 150. The data points may also be stored in client storage 115, which may comprise non-volatile storage, and/or client memory 120, which may comprise volatile storage, where the client memory 120 may provide faster data access speeds than the client storage 115. In some implementations, the set of data points may be requested and received from the database server 150 each time the user 101 authenticates. The set of data points may represent analytics data stored in database server 150, for example, analytics data representing product sales amounts or inventory levels.

According to implementations of the disclosed subject matter, forecasts (predictive outputs) for user relevant data may be generated. A forecast for a user relevant data may be based on contextually-relevant information, seasonality, trends, and key drivers associated with the user relevant data. User relevant data may be any applicable data that may, for example, change (e.g., over time, periodically, based on one or more triggers, etc.). User relevant data may be, for example, sales data, inventory data, customer data, use data, access data, interaction data, financial data, business data, etc.

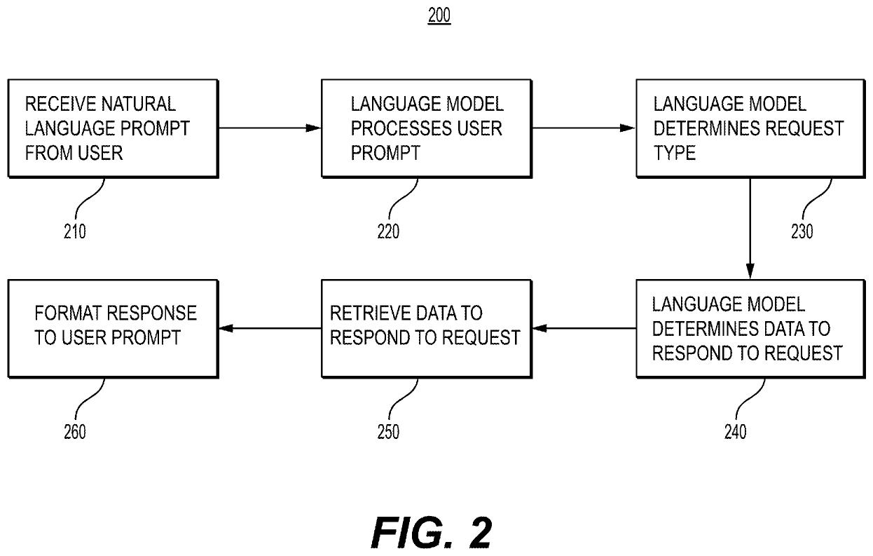

FIG. 2 depicts a system flow diagram 200 of a system for providing predictive outputs, according to one or more embodiments.

In operation 210, the system may receive a natural language prompt from a user. The prompt may, for example, relate to a time series forecast, a trend analysis, or a key driver analysis, as discussed in greater detail below. The user request may, for example, be provided to an artificial intelligence system, such as large language model (LLM) 111 depicted in FIG. 1. In operation 220, the system may, such as though LLM 111, process the user prompt. In operation 230, the system may, such as though LLM 111, determine a request type of the user prompt. For example, LLM 111 may determine whether the user prompt relates to a time series forecast, a trend analysis, or a key driver analysis. In operation 240, the system may, such as though LLM 111, determine what data is to be used to process the user prompt. For example, LLM may access metadata and terminology across broad data sets captured in a semantic graph to determine datasets and variables (i.e., metrics and attributes) that may be relevant to the user prompt. In operation 240, LLM 111 may output a computer readable query that may, for example, be provided to a database to request data associated with the natural language prompt. In operation 250, the system may retrieve data in order to respond to the user prompt (e.g., by providing the computer readable query to a database or other system component). In operation 260, the system may, such as though an artificial intelligence or machine learning process, or by other algorithmic means, formulate and format a response to the user prompt, such as by generating predictive data.

Data generated in response to the user prompt, such as, for example, future data points generated for a time series forecast chart, may be saved in a business intelligence (BI) system. Such generated data may then be used in response to later user queries. For example, the generated data may be blended with trusted or “governed” data stored in the BI system. This may allow for multi-pass analytics based on the blended data. For example, an analysis may perform a cohort evaluation and use the resulting cohort as a filter in subsequent steps (e.g., determining the top five product categories by return unit across all regions, predicting future sales statistics for those categories in the northeast region for the subsequent three months, and comparing those results to statistics for another region). In another example, an analysis result may trigger additional analysis or actions, such as when an analysis result exceeds or falls below a threshold value.

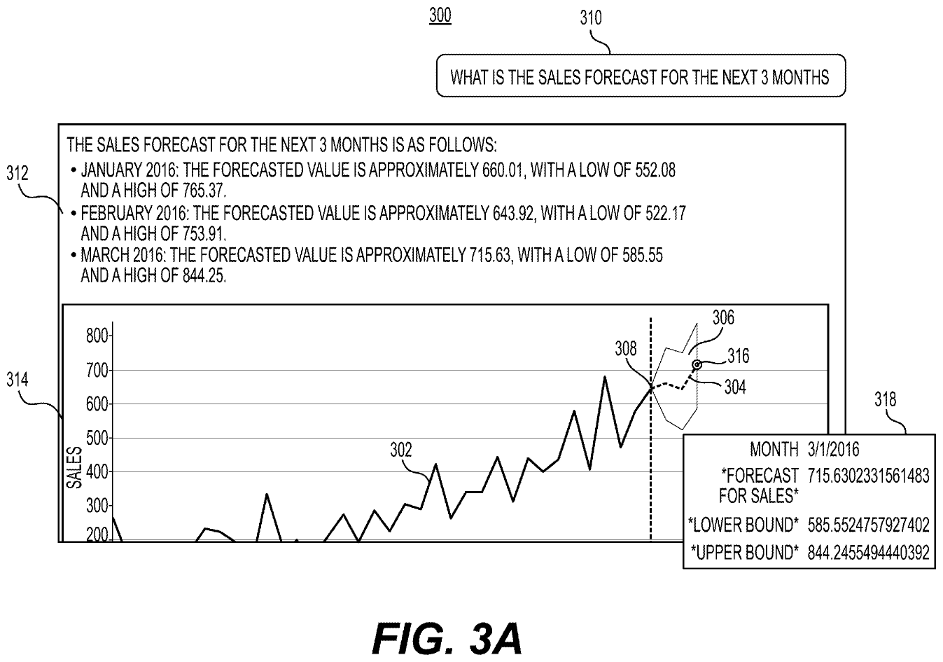

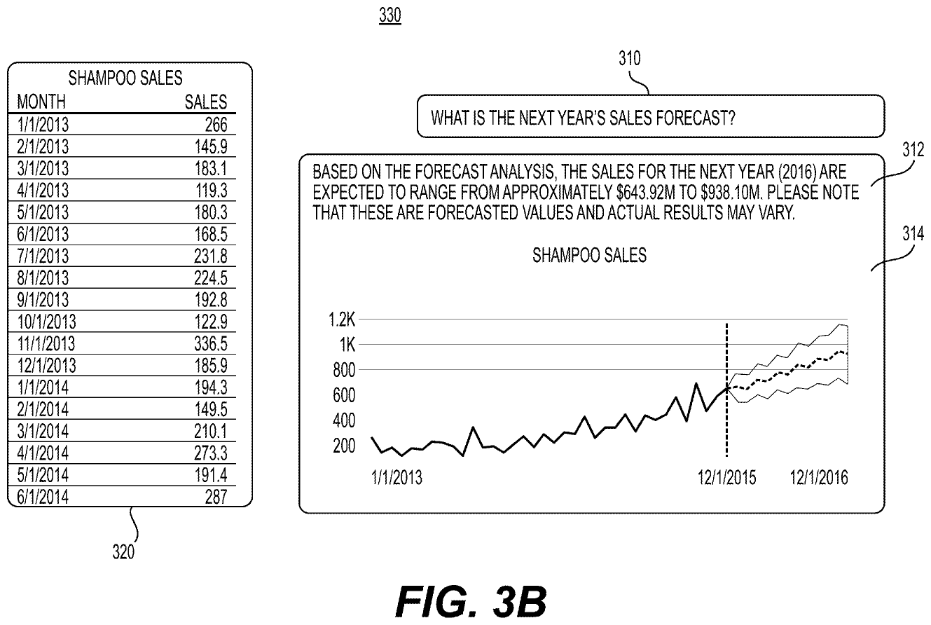

FIG. 3A depicts an example time series forecast chart 300, according to one or more embodiments. As shown in FIG. 3A, a user may enter a prompt via a text interface, such as, for example text box 310. However, other means of entering a prompt may be used such as, for example, speech-to-text, or other input methods. The user prompt may consist of a natural language query, such as, for example, “What's the projected sales for the next quarter?” The user prompt may be processed by an artificial intelligence or machine learning process, such as, for example LLM 111 depicted in FIG. 1 and discussed above, another artificial intelligence or machine learning process, or by other algorithmic means. In response to the user prompt received via text box 310, the system may generate a visualization, such as forecast chart 314, which may include historical data 302 and predictive data 304. The system may further generate a textual explanation 312 of forecast chart 314. Textual explanation 312 may, for example, include a clear natural language description of the forecasted data. The textual explanation and visualization may combine to assist the user in understanding the generated forecast.

The predictive data 304 may be based on historical data 302 and contextually-relevant information, seasonality, trends, and/or key drivers associated with the historical data 302. The duration of the predictive data, such as the number of months of predicted data is generated, may be specified by the user, such as a part of the user prompt, or may be automatically determined. The predictive data may be supplemented with a range 306. The range 306 may be the predictive variability expected for the predictive data 304. The range 306 may be determined based on an estimated certainty factor.

An estimated certainty factor may correspond to a confidence that a given user relevant data will fall within range 306 at a given future point in time. The estimated certainty factor may be provided by a user (e.g., approximately 90% certainty), such as part of the user prompt, or may be automatically generated. An automatically generated estimated certainty factor may be determined based on the historical data 302 and contextually-relevant information, seasonality, trends, and key drivers associated with the historical data 302. For example, a machine learning model may trained to determine an estimated certainty factor based on supervised and/or unsupervised training. The training may be conducted using tagged or untagged historical or simulated contextually-relevant information, seasonality, trends, and/or key drivers to modify or update one or more weights, layers, biases, or synapses of the machine learning model.

Additionally, predictive data 304 may be determined using a machine learning model. The machine learning model trained to determine predictive data 304 may be the same, part of, or different than the machine learning model trained to output the estimated certainty factor discussed herein.

According to implementations of the disclosed subject matter, predictive data 304 may be further based on external factors. External factors may include, but are not limited to, geolocation, demographics, weather, calendars, holidays, current events, or the like. Data associated with external factors may be sensed using one or more sensors such as a location sensor, weather sensor, ambient condition sensor, and/or the like. Sensed data sensed by such sensors may be recorded in a first format. The sensed data may be converted from the first format (e.g., a sensor format) into a second format associated with a machine learning model. The second format may be determined based on a property of such a machine learning model. For example, historical data 302 may be analyzed in view of one or more such external factors. A machine learning model may be trained by inputting historical external factors to identify patterns in historical data in view of such external data. A trained (e.g., production) machine learning model may be provided known or predicted external factors (e.g., weather information, calendar events, holidays, upcoming events, etc.). The trained machine learning model may apply contextually-relevant information, seasonality, trends, key drivers and/or the external factors to output predictive data 304.

According to an implementation, predictive data 304 may be updated based on updated contextually-relevant information, seasonality, trends, key drivers, and/or external factors. Predictive data 304 may be updated automatically, periodically, and/or based on triggers. For example, a trigger may be a change in one or more of contextually-relevant information, seasonality, trends, key drivers, and/or external factors.

According to another implementation, multiple estimated certainty factor bands may be provided, each band associated with a given estimated certainty factor. For example, a narrow band may be associated with a relatively low estimated certainty factor (e.g., approximately 20%) and a wide band may be associated with a relatively high estimated certainty factor (e.g., approximately 80%). Both a narrow band and a wide band may be provided via a graphical user interface (GUI). The estimated certainty factors associated with narrow bands and/or wide bands may be output by a machine learning model or may be provided by a user. The GUI may be generated based on the multiple estimated certainty factor bands and may be updated based on changes to the predictive data 304.

According to an implementation, a current data point 308 (e.g., associated with user relevant data) may be analyzed based on retroactive forecasting. A retroactive forecast may be a forecast determined at a point in time prior to a current time associated with current data point 308. For example, retroactive forecasting may be implemented at point 308 of forecast chart 314. According to this implementation, a forecast (e.g., predictive data) may be determined based on historical data 302 prior to point 308. Based on the retroactive forecasting, predictive data may be generated that provides a prediction for current data point 308. If the data (e.g., a value) of current data point 308 falls outside of the retroactive forecasting (e.g., based on data prior to point 208), then the current data point 308 may be identified as an outlier. One or more key drivers, as further discussed herein, may be identified as a cause for an outlier. The one or more outlier key drivers may be output by machine learning model trained to identify a relationship that caused a change in data greater than the retroactively forecasted predictive output. An outlier may be identified based on being placed outside a given estimated certainty factor bands. For example, a user or machine learning model may identify an outlier if a corresponding current data point falls outside a wide band, but may not identify an outlier if the corresponding current data point falls outside a narrow band.

In addition, a user may select a point in the forecast chart 314, such as a point 316 on historical data 302 or predictive data 304, to display detailed information 318 about that point. For example, the detailed information 318 may include information about the point within the time series (hour, day, month, quarter, year, etc.) and a value of the requested metric at that point, which may be, for example, a predicted value if a point on predictive data 304 is selected or a stored value if a point on historical data 302 is selected. In addition, if a point on predictive data 304 is selected, the detailed information 318 may include information about range 306, such as, for example, a lower band value and an upper band value. The user may select point 316 by any suitable means, such as, for example, clicking, hovering, highlighting, etc.

The generated visualization, such as forecast chart 314, may include a limited number of data points, based on constraints of the area available for the visualization or other factors. However, the entire set of existing and forecasted data points may be made available to the user. FIG. 3B depicts an additional example time series forecast chart 330, including display of underlying data, according to one or more embodiments. As shown in FIG. 3B, the system may provide and display to the user, in addition to textual explanation 312 and forecast chart 314, data underlying historical data 302 and/or predictive data 304, such as, for example, tabular information 320.

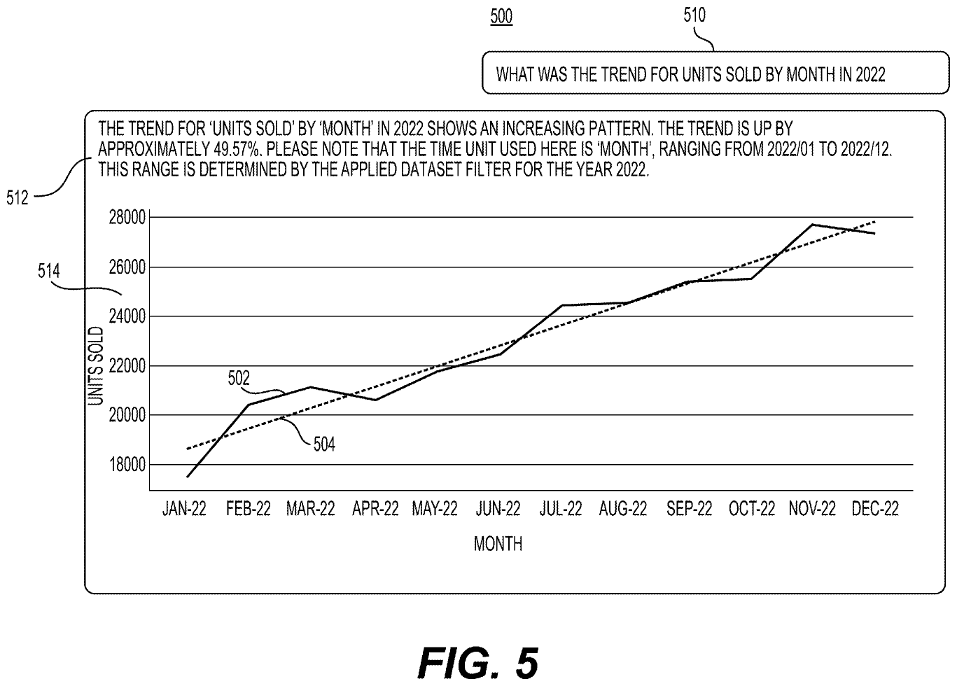

FIG. 5 shows charts 500 for determining trends and seasonality based on historical data 302 of FIG. 3A. As shown, observed data 502 may be received. Observed data 502 may be analyzed to extract a trend 504 associated with observed data 502. Trend 504 may be extracted using any applicable techniques such as, but not limited to, trend line determinations, best fit determinations, linear and/or non-linear reductions, smoothing, etc. Trend 504 may be used to determine predictive data 304 of FIG. 3A.

As shown in FIG. 5, seasonal trend 506 may be extracted from observed data 502. Seasonal trend 506 may be based on observed data 502 and/or a combination of the observed data and trend 504. For example, seasonal trend 506 may be extracted by removing trend 504 from observed data 502. Seasonal trend 506 may provide an indication of a periodic (e.g., time based) or event based fluctuation in observed data 502. Seasonal trend 506 may be used to determine predictive data 304 of FIG. 3A.

Further, as shown in FIG. 5, a residual trend 508 may be extracted from observed data 502. Residual trend 508 may be based on observed data 502, trend 504, seasonal trend 506, and/or a combination of the same. For example, residual trend 506 may be extracted by removing (or otherwise manipulating) trend 504 and seasonal trend 506 from observed data 502. Residual trend 508 may provide an indication of variability in observed data 502. Residual trend 508 may be used to determine predictive data 304 of FIG. 3A.

According to an implementation of the disclosed subject matter, automated actions may be triggered based on predictive data 304. For example, automated actions may include generating a notification, placing an order, adjusting resource (e.g., server, database, etc.) capacity, generating a report, or the like. The automated actions may be selected by a user and/or approved by a user. For example, automated action thresholds may be provided by a user or may be auto generated (e.g., by a machine learning model) and provided to a user (e.g., for approval). The automated action thresholds may be associated with an estimated certainty factor such that a minimum estimated certainty factor may be required to trigger an automated action. As an example, a report may be generated by formatting a visualization to prioritize trends that meet a first trend threshold (e.g., a level of observed change) and deprioritizing trends that do not meet the first trend threshold. Prioritizing a trend may include displaying a prioritized trend above a deprioritized trend, or increasing the amount of interface space occupied by a depiction of a prioritized trend in comparison to a deprioritized trend. Accordingly, an interface that provides the trend information may be organized based on the given trend data and may be different for different trend data.

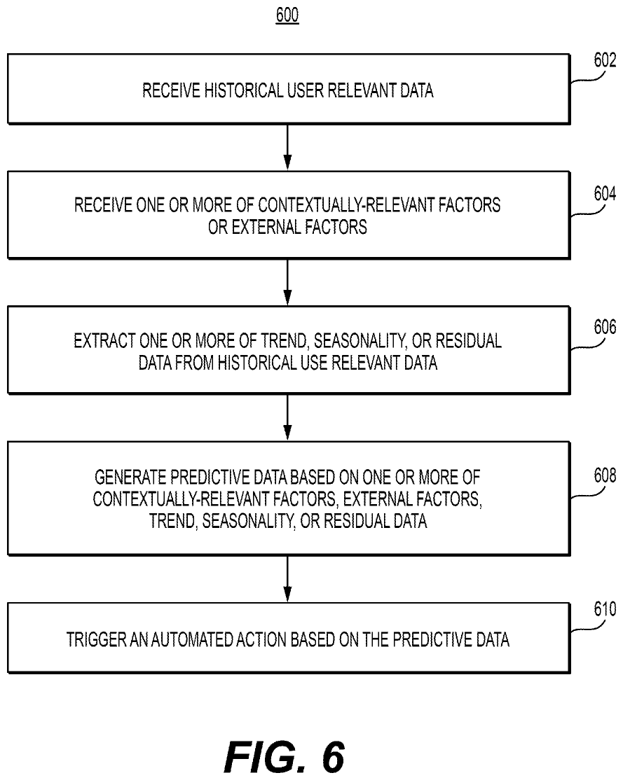

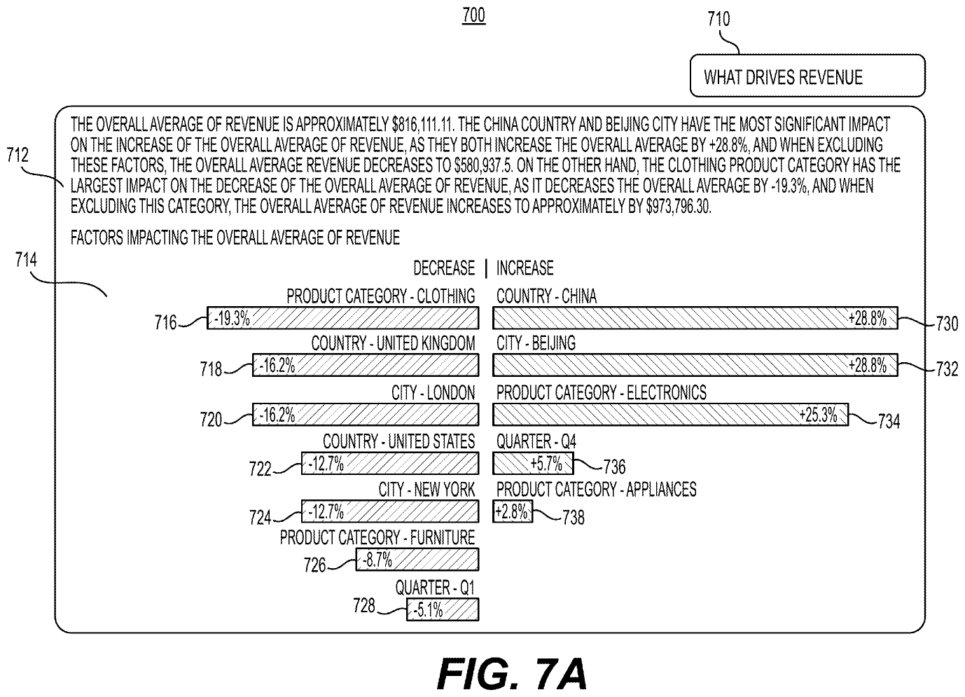

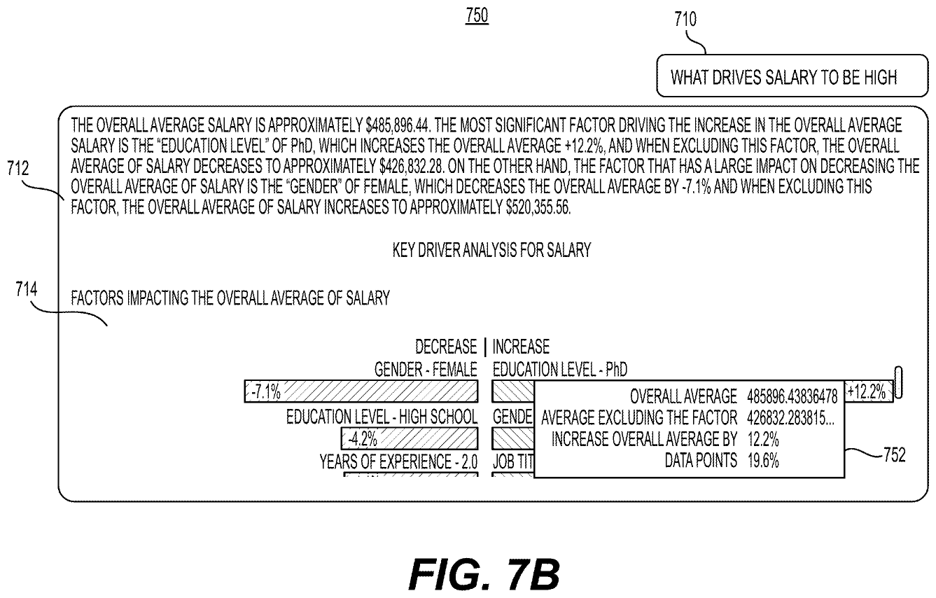

FIG. 6 depicts an example trend analysis, according to one or more embodiments. As shown in FIG. 6, a user may enter a prompt via a text interface, such as, for example text box 610. However, other means of entering a prompt may be used such as, for example, speech-to-text, or other input methods. The user prompt may be processed by an artificial intelligence or machine learning process, such as, for example LLM 111 depicted in FIG. 1 and discussed above, another artificial intelligence or machine learning process, or by other algorithmic means. In response to the user prompt received via text box 610, the system may generate a trend analysis chart 614, which may include historical data 602 and trend data 604. The system may further generate a textual explanation 612 of trend analysis chart 614. Trend analysis chart 614 may be generated by an algorithmic process, such as, for example, the process illustrated in FIG. 7.

FIG. 7 shows a flowchart 700 for determining predictive data. As disclosed herein, historical user relevant data may be received at step 702. At step 704, one or more of contextually-relevant factors and/or external factors may be received. At step 706, one or more of a trend, a seasonality, and/or residual data may be extracted from the historical user relevant data received at step 702. At step 708, predictive data may be generated based on one or more of the contextually-relevant factors, external factors, trend, a seasonality, and/or residual data. At step 710, an automated action may be triggered based on the predictive data.

According to an implementation of the disclosed subject matter, a key driver analysis may be conducted to identify key drivers that cause a change in user relevant data. The key driver analysis may be based on the semantic architecture disclosed herein. The semantic architecture may segregate historical user relevant data into a plurality of categories. The categories may be geographical categories, demographic categories, time categories, widget categories, service categories, business categories, marketing categories, advertising categories, weather categories, event categories, or the like. For example, categories associated with historical sales data may include geographical areas where sales occurred, age ranges for buyers corresponding to the sales, times of sale (e.g., by hour, day, week, month, year, season, etc.), weather corresponding to sales, current events occurring associated with the times of sales, etc.

The semantic architecture may further segregate a given category into a plurality of subcategories. The subcategories for a given category may be based on distinctions within the category. For example, a geographical category may further be subcategorized into a north, south, east, and west subcategory. A demographic category may be broken down into age range subcategories, gender subcategories, and/or the like. Accordingly, multiple types of subcategories may be associated with a given category. Further, subcategories may include further subcategories. For example, a geography category may include a north subcategory and a north subcategory may further include a north-east subcategory.

External factors, as discussed herein, may be applied as categories and/or subcategories. For example, weather data may be a category and types of weather (e.g., rain, sun, high temperatures, low temperatures, etc.) may be subcategories.

The key driver analysis may identify a change in user relevant data. If the user relevant data changes by a threshold amount, for example, then categories associated with the user relevant data may be analyzed to determine if any of the categories meet a category change threshold. The category change threshold may be a static threshold (e.g., a predetermined threshold, a user provided threshold, etc.) or a dynamic threshold (e.g., output by a machine learning model, determined based on the user relevant data, determined based on the category, determined based on the change in user relevant data, and/or determined based on changes in other categories, etc.).

If no category associated with given user relevant data meets a category change threshold, then it may be determined that no key drivers caused the change in user relevant data. If a category associated with the given user relevant data meets the category change threshold, then the category may be analyzed to determine if any respective subcategories meet a subcategory change threshold. The subcategory change threshold may be a static threshold (e.g., a predetermined threshold, a user provided threshold, etc.) or a dynamic threshold (e.g., output by a machine learning model, determined based on the user relevant data, determined based on the category, determined based on the subcategory, determined based on the change in user relevant data, and/or determined based on changes in other subcategories, etc.).

One or more categories that meet a corresponding threshold and/or one or more subcategories that meet a corresponding subcategory threshold may be flagged as a key driver. The flagged categories and/or subcategories may be provided to a user (e.g., via a notification, alert, interface, etc.). One or more automated actions, as disclosed herein in reference to forecast, may be triggered based on flagged categories and/or subcategories.

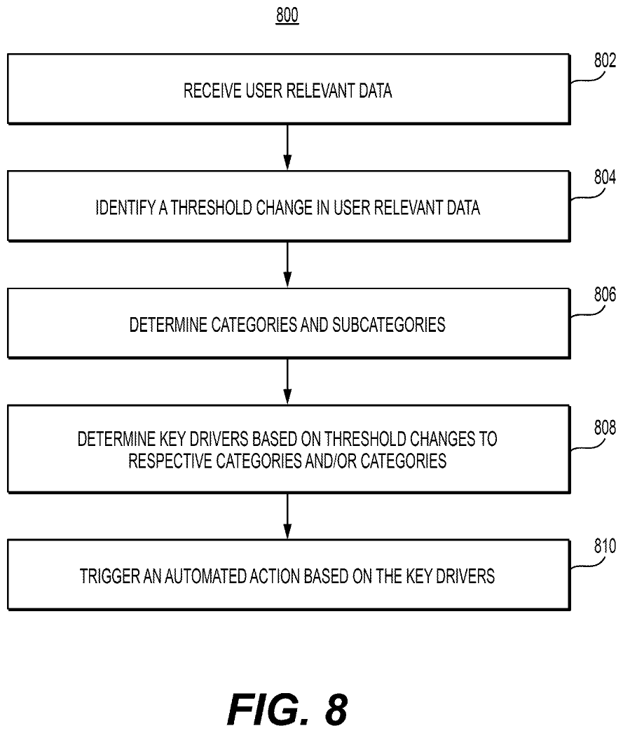

FIG. 8A depicts example subcategory key drivers, according to one or more embodiments. As shown in FIG. 8A, a user may enter a prompt via a text interface, such as, for example text box 810. However, other means of entering a prompt may be used such as, for example, speech-to-text, or other input methods. The user prompt may be processed by an artificial intelligence or machine learning process, such as, for example LLM 111 depicted in FIG. 1 and discussed above, another artificial intelligence or machine learning process, or by other algorithmic means. In response to the user prompt received via text box 810, the system may execute an analysis to determine the key drivers 816-838 that contributed, for example, to an increase or decrease in revenue. As a result of the analysis, for example, the clothing product category 816 may be flagged as a key driver for decreasing revenue, and the country 830 China maybe flagged as a key driver for increasing revenue. Based on the example shown in FIG. 8A, an automated action may trigger which may result in additional funds being allocated to content generation and coupon promotions.

According to an implementation, a minimum category or subcategory threshold may be implemented to identify non-key drivers. Based on the analysis, a notification may be provided and may indicate that that one or more drivers of, for example, revenue, are non-key drivers as because the non-key drivers did not drive a threshold change in revenue.

Key drivers may be comprised of sub-categories, each also being separate drivers. For example, a key driver associated with a geographical category may identify subcategory states California, New York, Washington, Virginia, Oregon, and Pennsylvania as subcategory sates that drove a change in revenue.

FIG. 8B depicts additional example key drivers, according to one or more embodiments. As shown in FIG. 8B, a user may select a key driver to display detailed information 852 about that key driver. For example, the detailed information 852 may include information about the overall average value of a metric (salary in the example shown in FIG. 8B), an average if the selected driver is excluded, an overall change in the metric if the selected driver is included, and a number or percentage of data points used in the analysis including the selected driver. The user may select the key driver by any suitable means, such as, for example, clicking, hovering, highlighting, etc.

Accordingly, implementations disclosed herein describe a key driver analysis conducted using a semantic architecture that includes dimensions of categories and subcategories associated with user relevant data. The semantic architecture may be used to iteratively drill down on category based data changes and further on subcategory based data changes to identify key drivers. The key driver analysis may continue to iterate until category and/or subcategory thresholds are not met. Once a category and/or subcategory threshold for a given category and/or subcategory has not been met, the category or subcategory directly above (e.g., the category or subcategory that subsumes the given category and/or subcategory) may be flagged as a key driver.

FIG. 8 shows a flowchart 800 for determining key drivers. As disclosed herein, user relevant data may be received at step 802. At step 804, a threshold change in the user data may be identified. At step 806, one or more categories and corresponding subcategories associated with the user data may be determined (e.g., using a semantic architecture). At step 808, one or more key drivers corresponding to the threshold change identified at step 804 may be determined based on respective category thresholds and/or subcategory thresholds, in accordance with the techniques disclosed herein. At step 410, an automated action may be triggered based on the one or more key drivers.

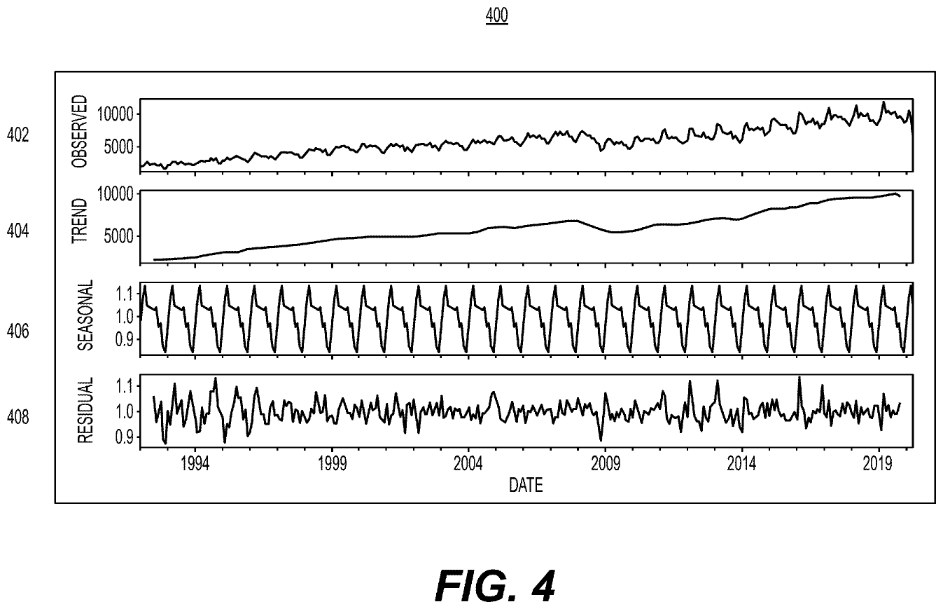

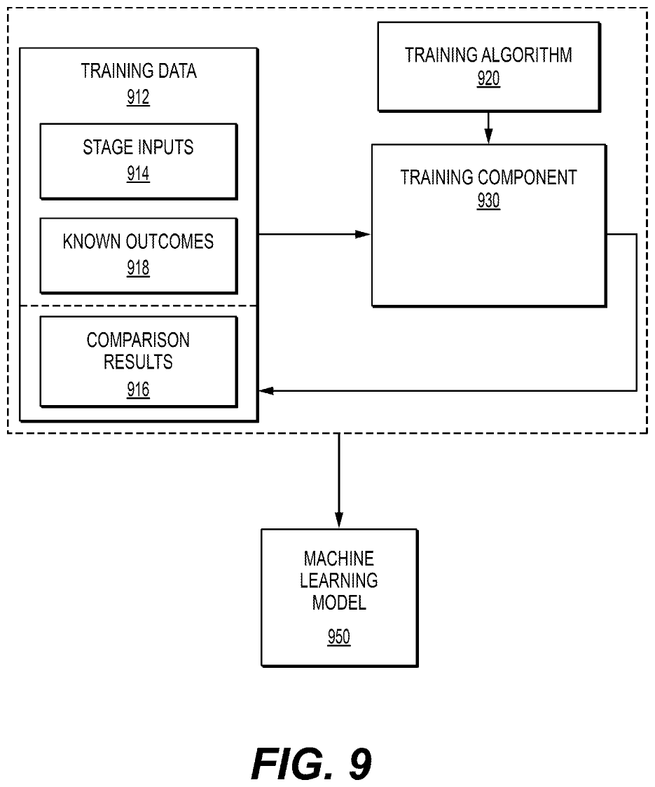

One or more implementations disclosed herein may be implemented using a machine learning model 950 of FIG. 9. Such a machine learning model may be trained using the data flow 910 of FIG. 9. Training data 912 may include one or more of stage inputs 914 and known outcomes 918 related to a machine learning model to be trained. The stage inputs 914 may be from any applicable source including data input or output from a component, step, or module discussed herein and/or as shown in FIGS. 1-8. The known outcomes 918 may be included for machine learning models generated based on supervised or semi-supervised training. An unsupervised machine learning model may not be trained using known outcomes 918. Known outcomes 918 may include known or desired outputs for future inputs similar to or in the same category as stage inputs 914 that do not have corresponding known outputs.

The training data 912 and a training algorithm 920 may be provided to a training component 930 that may apply the training data 912 to training algorithm 920 to generate a machine learning model. According to an implementation, training component 930 may be provided comparison results 916 that compare a previous output of the corresponding machine learning model to apply the previous result to re-train the machine learning model. Comparison results 916 may be used by training component 930 to update the corresponding machine learning model. Training algorithm 920 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. Training algorithm 920 and/or the training disclosed in FIG. 9 may be used to modify one or more of weights, layers, nodes, synopsis, or the like of an initial machine learning model to generate machine learning model 950 based on the training data 912 and training component 930.

A number of implementations have been described. Nevertheless, it will be understood that various modifications may be made without departing from the spirit and scope of the disclosure. For example, various forms of the flows shown above may be used, with steps re-ordered, added, or removed.

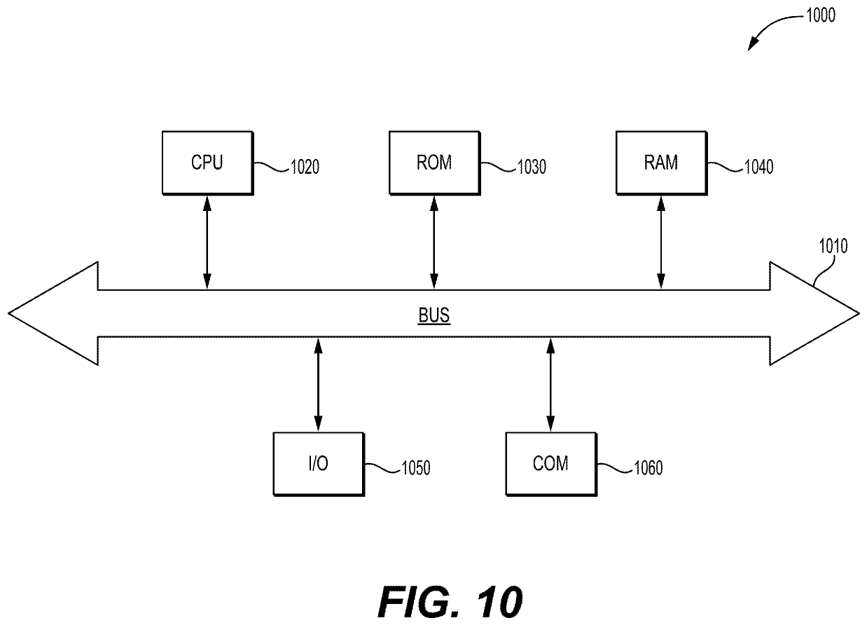

FIG. 10 depicts a high-level functional block diagram of an exemplary computer device or system, in which embodiments of the present disclosure, or portions thereof, may be implemented, e.g., as computer-readable code. Additionally, each of the exemplary computer servers, databases, user interfaces, modules, and methods described above with respect to FIGS. 1-9 can be implemented in device 1000 using hardware, software, firmware, tangible computer readable media having instructions stored thereon, or a combination thereof and may be implemented in one or more computer systems or other processing systems. Hardware, software, or any combination of such may implement each of the exemplary systems, user interfaces, and methods described above with respect to FIGS. 1-9.

If programmable logic is used, such logic may be executed on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor or a plurality of processors, or combinations thereof. Processor devices may have one or more processor “cores.”

Various embodiments of the present disclosure, as described above in the examples of FIGS. 1-9, may be implemented using device 1000. After reading this description, it will become apparent to a person skilled in the relevant art how to implement embodiments of the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As shown in FIG. 10, device 1000 may include a central processing unit (CPU) 1020. CPU 1020 may be any type of processor device including, for example, any type of special purpose or a general-purpose microprocessor device. As will be appreciated by persons skilled in the relevant art, CPU 1020 also may be a single processor in a multi-core/multiprocessor system, such system operating alone, or in a cluster of computing devices operating in a cluster or server farm. CPU 1020 may be connected to a data communication infrastructure 1010, for example, a bus, message queue, network, or multi-core message-passing scheme.

Device 1000 also may include a main memory 1040, for example, random access memory (RAM), and also may include a secondary memory 1030. Secondary memory 1030, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 1030 may include other similar means for allowing computer programs or other instructions to be loaded into device 1000. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 1000.

Device 1000 also may include a communications interface (“COM”) 1060. Communications interface 1060 allows software and data to be transferred between device 1000 and external devices. Communications interface 1060 may include a modem, a network interface (such as an Ethernet card), a communications port, a PCMCIA slot and card, or the like. Software and data transferred via communications interface 1060 may be in the form of signals, which may be electronic, electromagnetic, optical, or other signals capable of being received by communications interface 1060. These signals may be provided to communications interface 1060 via a communications path of device 1000, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 1000 also may include input and output ports 1050 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method for providing predictive outputs and key drivers, the method comprising:
receiving a prompt from a user;
providing the prompt to an artificial intelligence process;
receiving, from the artificial intelligence process, an analysis of the prompt, the analysis including one or more of: an identified type of predictive data requested by the prompt, one or more identified metrics related to the prompt, one or more identified data attributes related to the prompt, a determined granularity of data for a response to the prompt, one or more filters applied to data related to the prompt, and a determined timeframe of analysis for a response to the prompt;
retrieving the data related to the prompt;
applying the one or more filters to the retrieved data;
generating the identified type of predictive data according to the one or more identified metrics, the one or more identified data attributes, the determined granularity of data, and the determined timeframe of analysis; and
presenting the generated predictive data to the user.

2. The computer-implemented method of claim 1, wherein the artificial intelligence process is a large language model.

3. The computer-implemented method of claim 1, wherein the determined granularity of data is per millisecond, per second, per minute, per hour, per day, per month, per quarter, or per year.

4. The computer-implemented method of claim 1, wherein the identified type of predictive data requested by the prompt is one of: a time series forecast, and trend analysis, or a key driver analysis.

5. The computer-implemented method of claim 1, the method further comprising:
storing the generated predictive data; and
determining additional predictive data using the stored generated predictive data.

6. The computer-implemented method of claim 1, wherein the data is trusted.

7. The computer-implemented method of claim 1, further comprising:
storing the prompt, the analysis of the prompt, and the generated predictive data in a database with information about past user prompts,
wherein generating the identified type of predictive data is further based on the information about past user prompts.

8. The computer-implemented method of claim 1, wherein the analysis is performed by a machine learning process.

9. The computer-implemented method of claim 1, further comprising:
receiving historical user relevant data;
receiving at least one of contextually-relevant factors or external factors; and
extracting at least one of a trend, a seasonality, or a residual data from the historical user relevant data,
wherein generating the predictive data is further based on at least one of the contextually-relevant factors, the external factors, the trend, the seasonality, or the residual data.

10. The computer-implemented method of claim 1, further comprising:
triggering an automated action based on the generated predictive data.

11. The computer-implemented method of claim 10, wherein the automated action is based on the predictive data meeting a predictive data threshold.

12. The computer-implemented method of claim 1, further comprising:
providing, to the artificial intelligence process, metadata describing one or more available metrics and metadata describing one or more available data attributes.

13. A system for providing predictive outputs and key drivers, the system comprising:
a data storage device storing instructions for providing predictive outputs and key drivers in an electronic storage medium; and
a processor configured to execute the instructions to perform a method including:
receiving a prompt from a user;
providing the prompt to an artificial intelligence process;
receiving, from the artificial intelligence process, an analysis of the prompt, the analysis including one or more of: an identified type of predictive data requested by the prompt, one or more identified metrics related to the prompt, one or more identified data attributes related to the prompt, a determined granularity of data for a response to the prompt, one or more filters applied to data related to the prompt, and a determined timeframe of analysis for a response to the prompt;
retrieving the data related to the prompt;
applying the one or more filters to the retrieved data;
generating the identified type of predictive data according to the one or more identified metrics, the one or more identified data attributes, the determined granularity of data, and the determined timeframe of analysis; and
presenting the generated predictive data to the user.

14. The system of claim 13, wherein the identified type of predictive data requested by the prompt is one of: a time series forecast, and trend analysis, or a key driver analysis.

15. The system of claim 13, wherein the system is further configured for:
storing the generated predictive data; and
determining additional predictive data using the stored generated predictive data.

16. The system of claim 13, wherein the system is further configured for:
providing, to the artificial intelligence process, metadata describing one or more available metrics and metadata describing one or more available data attributes.

17. A non-transitory machine-readable medium storing instructions that, when executed by a computing system, causes the computing system to perform a method for providing predictive outputs and key drivers, the method including:
receiving a prompt from a user;
providing the prompt to an artificial intelligence process;
receiving, from the artificial intelligence process, an analysis of the prompt, the analysis including one or more of: an identified type of predictive data requested by the prompt, one or more identified metrics related to the prompt, one or more identified data attributes related to the prompt, a determined granularity of data for a response to the prompt, one or more filters applied to data related to the prompt, and a determined timeframe of analysis for a response to the prompt;
retrieving the data related to the prompt;
applying the one or more filters to the retrieved data;
generating the identified type of predictive data according to the one or more identified metrics, the one or more identified data attributes, the determined granularity of data, and the determined timeframe of analysis; and
presenting the generated predictive data to the user.

18. The non-transitory machine-readable medium of claim 17, wherein the identified type of predictive data requested by the prompt is one of: a time series forecast, and trend analysis, or a key driver analysis.

19. The non-transitory machine-readable medium of claim 17, the method further comprising:
storing the prompt, the analysis of the prompt, and the generated predictive data in a database with information about past user prompts,
wherein generating the identified type of predictive data is further based on the information about past user prompts.

20. The non-transitory machine-readable medium of claim 17, the method further comprising:
providing, to the artificial intelligence process, metadata describing one or more available metrics and metadata describing one or more available data attributes.
